(19) United States
(12) Patent Application Publication
(10) Pub. No.: US 2013/0043823 A1
(43) Pub. Date: Feb. 21, 2013

(54) CONTROL DEVICE FOR AN ASYNCHRONOUS ELECTRIC MACHINE, ELECTRIC PROPULSION SYSTEM COMPRISING SAID DEVICE, AND METHOD FOR CONTROLLING AN ASYNCHRONOUS ELECTRIC MACHINE

(71) Applicants: Daniela Baratta, Genova (IT); Massimo Caneparo, Genova (IT); Paolo Verrecchia, Genova (IT)

(72) Inventors: Daniela Baratta, Genova (IT); Massimo Caneparo, Genova (IT); Paolo Verrecchia, Genova (IT)

(73) Assignee: ANSALDO ENERGIA S.P.A., GENOVA (IT)

(21) Appl. No.: 13/518,341

(22) PCT Filed: Dec. 30, 2010
(86) PCT No.: PCT/IT10/00521

§ 371 Date: Nov. 1, 2012

(30) Foreign Application Priority Data
Dec. 30, 2009 (IT) TO2009A001058

(51) Int. Cl. H02P 23/08

(52) U.S. Cl. 318/798

(57) ABSTRACT

A control device for an asynchronous electric machine comprises a first computing unit configured for defining a first signal, which is correlated to an operating voltage to be applied to the electric machine. The first signal is defined as a function of a second signal indicating a desired stator frequency of the operating voltage, and as a function of a third signal indicating a desired slip frequency of the electric machine.

### TECHNICAL FIELD

The present invention relates to a control device for an asynchronous electric machine.

In particular, the present invention regards a control device for an asynchronous electric machine, comprising a first computing unit configured for defining a first signal, correlated to an operating voltage to be applied to the electric machine, as a function of a second signal indicating a desired stator frequency of the operating voltage.

### BACKGROUND ART

Generally, the control device computes the desired stator frequency on the basis of a rotor angular velocity detected through an angular-velocity detection module coupled to a rotor of the electric machine, and on the basis of a desired slip frequency calculated on the basis of the detected rotor angular velocity and of a reference input angular velocity supplied through a user interface.

The first computing unit determines the value of the operating voltage exclusively on the basis of the desired stator frequency; in fact, the first computing module receives at input exclusively the second signal. The first computing unit defines the value of the operating voltage in such a way that the electric machine is able to supply a given value of nominal torque associated to the desired stator frequency.

A technical problem present in the known art is that the electric machine is supplied in such a way that it can deliver always the given value of nominal torque associated to the desired stator frequency even if the torque requirement is lower than said value of nominal torque.

### DISCLOSURE OF INVENTION

An aim of the present invention is to provide a control device that will limit the drawbacks of the known art.

Another aim of the present invention is to provide a control device designed to control the asynchronous electric machine so as to reduce the levels of consumption of the electric machine.

In accordance with the above aims, a control device for an asynchronous electric machine is provided, comprising a first computing unit configured for defining a first signal, correlated to an operating voltage to be applied to the electric machine, as a function of a second signal indicating a desired stator frequency of the operating voltage, and as a function of a third signal indicating a desired slip frequency of the electric machine.

The control device, in particular the first computing unit, computes the operating voltage to be applied to the electric machine also on the basis of the desired slip frequency. In this way, the control device regulates the torque delivered and reduces the levels of consumption of the electric machine.

Another aim of the present invention is to provide an electric propulsion system that will overcome the drawbacks of the known art.

According to the present invention, an electric propulsion system is provided, comprising an asynchronous electric machine, a source of electrical energy for supplying the asynchronous electric machine, and a control device, according to any one of claims 1 to 11.

Another aim of the present invention is to provide a method for controlling an asynchronous electric machine that will overcome the drawbacks of the known art.

According to the present invention a method for controlling an asynchronous electric machine is provided, comprising the step of defining a first signal, correlated to an operating voltage to be applied to the electric machine, as a function of a second signal indicating a desired stator frequency of the operating voltage, and as a function of a third signal indicating a desired slip frequency of the electric machine.

### BRIEF DESCRIPTION OF THE DRAWINGS

Further characteristics and advantages of the present invention will emerge clearly from the ensuing description of its non-limiting examples of embodiment, with reference to the figures of the annexed drawings, wherein:

FIG. 1 is a simplified scheme of an electric propulsion system;

FIG. 2 is a detail of a particular of FIG. 1; and

FIG. 3 is a graph of quantities used in the electric propulsion system.

### BEST MODE FOR CARRYING OUT THE INVENTION

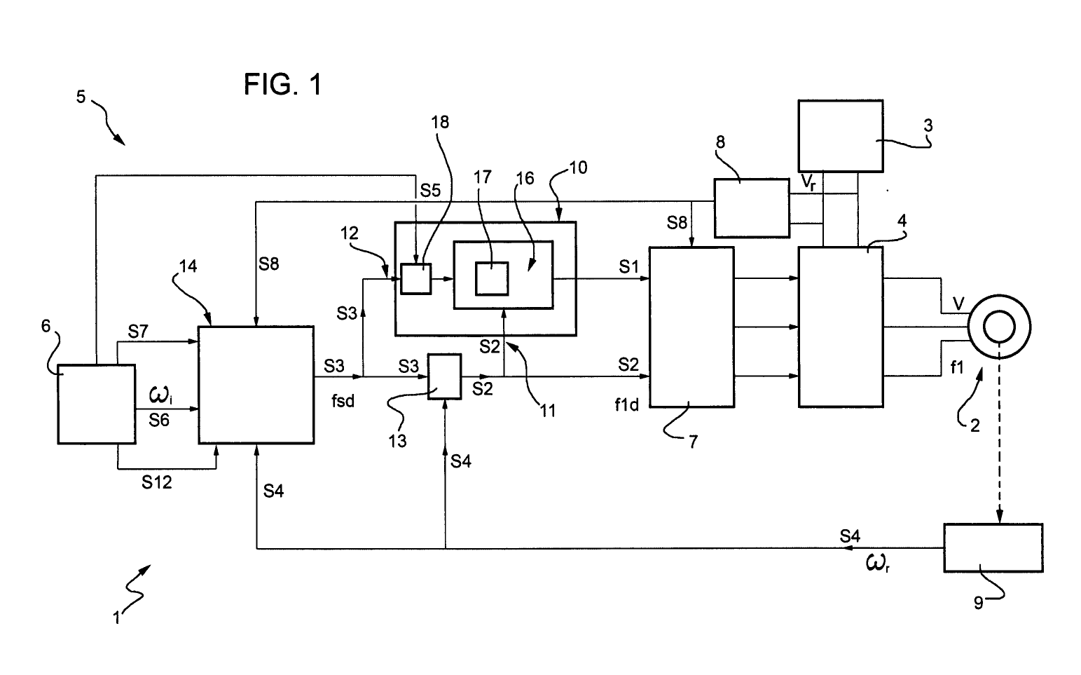

With reference to FIG. 1, designated by the number 1 is an electric propulsion system in particular for motor vehicles.

The electric propulsion system 1 for motor vehicles comprises: a multiphase asynchronous electric machine 2 comprising a stator and a rotor; a source of electrical energy 3 for supplying the asynchronous electric machine 2, generally rechargeable batteries, for example lithium-ion or lithium-polymer batteries, NiMh batteries, or lead batteries; power switches 4, set between the source of electrical energy 3 and the electric machine 2 for supplying an operating voltage V to the electric machine 2; a control device 5 for controlling the electric machine 2; and a user interface 6.

The electric machine 2, in use, is supplied by the operating multiphase voltage V supplied through the power switches 4. The operating voltage V is characterized by a stator frequency f1 that is in relation with the angular velocity of a first rotary magnetic field produced by the stator. In use, the rotor of the electric machine 2 turns at a rotor angular velocity proportional to the rotor frequency and corresponding to the angular velocity of a second rotary magnetic field produced by the rotor and interacting with the first rotary magnetic field. The difference between the stator frequency f1 and the rotor frequency determines a slip frequency.

The electric propulsion system 1 comprises a control unit 7 for controlling the power switches 4.

The control device 5 controls the operating voltage V supplied to the electric machine 2 and the stator frequency f1 through the control unit 7 for controlling the power switches 4. For said purpose, the control device 5 supplies to the control unit 7 a signal S1 indicating the operating voltage V to be applied to the electric machine 2 and a signal S2 indicating a desired stator frequency f1d of the operating voltage V.

The control device 5 comprises a voltage-metering module 8, which is coupled to the source of electrical energy 3 and is designed to detect a reference voltage Vr of the source of electrical energy 3 and supply a signal S8 indicating the reference voltage Vr.

The control unit 7 receives at input the signal S1, the signal S2, and the signal S8 and is configured for controlling the power switches 4 in such a way as to supply to the electric machine 2 the operating voltage V indicated by the signal S1 at a stator frequency f1 equal to the desired stator frequency f1d indicated by the signal S2. In a preferred embodiment, the control unit 7 operates with a pulse-width-modulation (PWM) control on the power switches 4 on the basis of the operating voltage V, the desired stator frequency f1d, and the reference voltage Vr of the supply source.

The control device 5 comprises an angular-velocity detection module 9 coupled to the rotor, which detects the rotor angular velocity of the rotor and defines a signal S4 indicating a detected rotor angular velocity ωr. The rotor angular velocity is proportional to the rotor frequency. Consequently, the detected rotor angular velocity ωr defines a detected rotor frequency. In a preferred embodiment, the velocity detection module 9 is an encoder coupled to the rotor of the electric machine 2.

The control device 5 comprises a computing unit 10, configured for defining the signal S1 indicating the operating voltage V as a function of the signal S2 indicating the desired stator frequency f1d of the operating voltage V, and as a function of a signal S3 indicating a desired slip frequency fsd of the electric machine 2. For said purpose, the computing unit 10 comprises a port 11 for receiving at input the signal S2 and a port 12 for receiving at input the signal S3. In addition, the user interface 6 is configured for supplying a signal S5 for issuing a command for reduction of the consumption of the electric propulsion system 1.

The control device 5 comprises a computing module 13 for defining the signal S2 on the basis of the signal S3 and of the signal S4. In particular, the computing module 13 calculates the detected rotor frequency from the detected rotor angular velocity ωr supplied by the signal S4 and defines the signal S2 in such a way that it indicates the sum of the desired slip frequency fsd indicated by the signal S3 and of the detected rotor frequency.

The control device 5 comprises a computing unit 14 configured for defining the signal S3 as a function of the signal S4, of a signal S6 correlated to a reference input angular velocity ωi supplied through the user interface 6, of a signal S7 supplied by the user interface 6 and correlated to a command for braking the electric machine 2, and of the signal S8.

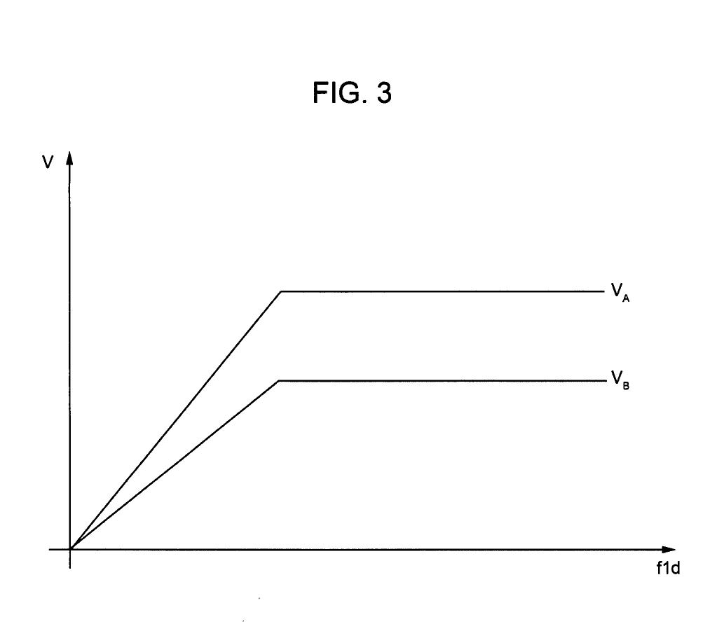

The computing unit 10 comprises a computing module 16, configured for supplying a respective first value of the operating voltage V and a respective second value of the operating voltage V for each admissible value of the desired stator frequency f1d of the electric machine 2. For said purpose, the computing module 16 comprises a memory 17, including two voltage functions VA and VB, where the operating voltage V is the dependent variable and the desired stator frequency f1d is the independent variable, as represented in FIG. 3. The function VA defines maximum values of the operating voltage V to be applied to the electric machine 2 as a function of the desired stator frequency f1d. The function VB defines minimum values of the operating voltage V to be applied to the electric machine 2 as a function of the desired stator frequency f1d. All the values of operating voltage V comprised between the maximum values and the minimum values are voltage values that can be applied to the electric machine 2.

In addition, the computing module 16 is configured for defining a set of voltage values as a function of the value of the desired stator frequency f1d and of the first value and of the second value of the operating voltage V associated to the value of the desired stator frequency f1d and for defining a value of the signal S1, comprised in a set of voltage values, as a function of a value of the desired slip frequency fsd. In other words, the computing module 16 defines a minimum value and a maximum value of the operating voltage V on the basis of the value of desired stator frequency f1d and determines, on the basis of the value of desired slip frequency fsd, a value of operating voltage V comprised between the minimum value and the maximum value of the operating voltage V.

In addition, the computing unit 10 comprises a computing module 18, which is configured for defining the value of the desired slip frequency fsd to be processed for defining the signal S1. For said purpose, the computing module 18 is coupled to the computing module 16 and receives at input the signal S3. The computing module 18 operates in the following way: it defines the value of desired slip frequency fsd equal to zero and supplies it to the computing module 16, if the signal S3 indicates a negative value of the desired slip frequency fsd; and it defines the value of the desired slip frequency fsd following upon processing, on the basis of the signal S5 supplied by the user interface 6, of the value of desired slip frequency fsd defined by the signal S3, if the signal S3 indicates a positive value of the desired slip frequency fsd.

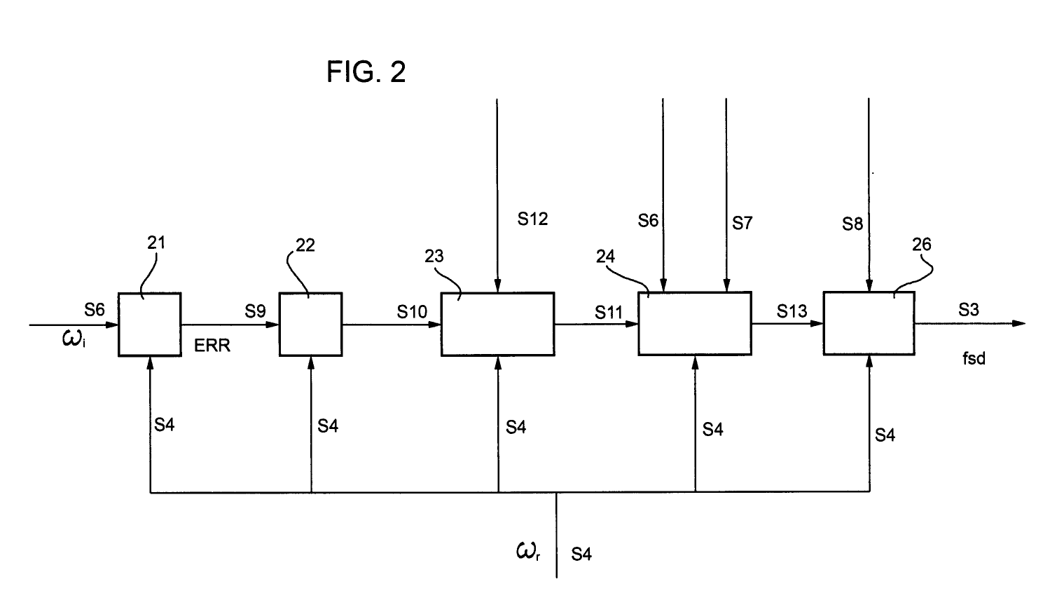

With reference to FIG. 2, the computing unit 14 comprises a computing module 21 configured for defining a signal S9 correlated to an error of angular velocity ERR from the comparison between the signal S6, indicating the reference input angular velocity ωi, and the signal S4, indicating the detected rotor angular velocity ωr. For said purpose, the computing module 21 defines the error of angular velocity ERR from the comparison between the detected rotor angular velocity ωr and the reference input angular velocity ωi. In particular the error of angular velocity ERR indicates the difference between the reference input angular velocity ωi and the detected rotor angular velocity ωr.

The computing unit 14 comprises a computing module 22 configured for defining a signal S10 obtained by applying a variable gain to the signal S9, the variable gain being a function of the signal S4. In particular, the computing module defines the signal S10 by amplifying or attenuating the signal S9 on the basis of the signal S4, i.e., on the basis of the detected rotor angular velocity ωr.

The computing unit 14 comprises a computing module 23 for calculating an acceleration on the basis of the signal S4 and for defining a signal S11 obtained by processing the signal S10 on the basis of the acceleration calculated and on the basis of a signal S12 supplied by the user interface 6. The signal S12 is associated and defined by a command for reduction of consumption supplied by the user interface 6.

In particular, the computing module 23 defines the signal S11 from the signal S10 so as to limit the signal S10 on the basis of a threshold, said threshold being variable on the basis of the acceleration calculated and to the detected rotor angular velocity ωr.

The computing unit 14 comprises a computing module 24 for defining a signal S13 on the basis of the signal S11, the signal S4, the signal S6, and the signal S7. In other words, the computing module 24 processes the signal S11 taking into account the detected rotor angular velocity ωr, the reference input velocity ωi, and the command for braking the electric machine. In particular, the computing module 24 defines a signal S13 by processing the signal S11 so as to attenuate the variations in a unit of time of the signal S11 and in such a way that in steady-state conditions the signal S13 will reach the value defined by the signal S11. The attenuation of the variations per unit time is defined on the basis of the signals S4, S6, and S7. For example, the signal S13 increases according to a ramp until it reaches the signal S11, and the slope of the ramp is defined by the signals S4, S6, and S7. In other words, if the signal S11 varies in a way discontinuous in time, the signal S13 will vary more slowly according to a ramp so as to reach the value defined by the signal S11 in a longer time interval.

In this way, also the torque delivered by the electric machine 2 is regulated since the slip frequency and the torque delivered are in relation with one another.

The computing unit 14 comprises a computing module 26 configured for defining the signal S3 obtained by processing the signal S13 as a function of the signal S8 and on the basis of the signal S4 so as to limit the desired slip frequency fsd of the electric machine 2 on the basis of the physical parameters of the electric machine 2. In other words, the signal S3 is obtained from the processed signal S13 so as to limit it on the basis of the voltage of the source of electrical energy 3 and on the basis of the detected rotor angular velocity ωr. In particular, the desired slip frequency fsd is limited to a maximum value that is a function of the detected rotor angular velocity or and is obtained on the basis of the physical parameters of the electric machine 2 to prevent breakdown or instability of the electric machine 2. In addition, the desired slip frequency fsd is limited on the basis of the source of electrical energy 3, in particular on the basis of the detected reference voltage Vr, said voltage being correlated to the residual energy of the source of electrical energy 3. Consequently, if the residual energy is lower than a certain limit, the desired slip frequency fsd is reduced in such a way that the electric machine 2 can be supplied and function for a longer time with lower performance.

According to an alternative embodiment of the present invention, the memory 17 comprises a table in which a value of the operating voltage V is present for each admissible value of desired stator frequency f1d and for each admissible value of desired slip frequency fsd. Consequently, each value of the operating voltage V is associated to a value of desired stator frequency f1d and to a value of desired slip frequency fsd. The computing unit 14 defines the signal S1 on the basis of the value of the operating voltage V of the table associated to the value of the desired stator frequency f1d indicated by the signal S2 and on the basis of the value of the desired slip frequency f2d indicated by the signal S3.

According to an alternative embodiment of the present invention, the computing module 16 is configured for defining a minimum value and a maximum value of the operating voltage V on the basis of the value of desired slip frequency fsd and for determining, on the basis of the value of desired stator frequency f1d, a value of operating voltage V comprised between the minimum value and the maximum value of the given operating voltage V. For said purpose, the memory 17 comprises two voltage functions, which define maximum values and minimum values of the operating voltage V to be applied to the electric machine 2 as a function of a desired slip frequency fsd. All the values of operating voltage V comprised between the maximum values and the minimum values are voltage values that can be applied to the electric machine 2. Furthermore, the computing module 16 is configured for defining a set of voltage values as a function of the value of the desired slip frequency fsd and of the first value and of the second value of the operating voltage V associated to the value of the desired slip frequency fsd and for defining a value of the signal S1, comprised in a set of voltage values, as a function of a value of the desired stator frequency f1d. In other words, the computing module 16 defines a minimum value and a maximum value of the operating voltage V on the basis of the value of desired slip frequency fsd and determines, on the basis of the value of desired stator frequency f1d, a value of operating voltage V comprised between the determined minimum value and maximum value of the operating voltage V.

Finally, it is clear that modifications and variations may be made to the control device, to the electric propulsion system, and to the control method described herein, as well as to use thereof, without thereby departing from the scope of the annexed claims.

1. A control device for an asynchronous electric machine (2), comprising a first computing unit (10) configured for defining a first signal (S1), correlated to an operating voltage (V) to be applied to the electric machine (2), as a function of a second signal (S2) indicating a desired stator frequency (f1d) of the operating voltage (V), and as a function of a third signal (S3) indicating a desired slip frequency (fsd) of the electric machine (2).

2. The device according to claim 1, wherein the first computing unit (10) comprises at least one port (11, 12) for receiving at input the second signal (S2) and the third signal (S3).

3. The device according to claim 1, comprising a first computing module (13) for defining the second signal (S2) on the basis of the third signal (S3) and of a fourth signal (S4) correlated to a detected rotor frequency, preferably by adding the desired slip frequency (fsd) indicated by the third signal (S3) to the detected rotor frequency; the control device (5) preferably comprising a velocity-detection module (9) coupled to the electric machine (2) for supplying the fourth signal (S4).

4. The device according to claim 1, wherein the first computing unit (10) is configured for supplying a respective first value of the operating voltage (V) and a respective second value of the operating voltage (V) for each admissible value of a first desired quantity chosen between the desired slip frequency (fsd) and the desired stator frequency (f1d) of the electric machine (2).

5. The device according to claim 4, wherein the first computing unit (10) is configured for defining a set of voltage values as a function of a value of the first desired quantity and of the first value and of the second value of the operating voltage (V) that are associated to the value of the first desired quantity and for defining a value of the first signal (S1) comprised in the set of voltage values and as a function of a value of a second desired quantity chosen between the desired stator frequency (f1d) and the desired slip frequency (fsd) and distinct from the first desired quantity.

6. The device according to claim 5, wherein the first computing unit (10) is configured for defining the value of the first signal (S1) on the basis of:
a zero value of the desired slip frequency (fsd), if the third signal (S3) indicates a negative value of the desired slip frequency (fsd); and
a value of the desired slip frequency (fsd) deriving from the value of desired slip frequency (fsd) defined by the third signal (S3) and modified on the basis of a fifth signal (S5) supplied by a user interface (6), if the third signal (S3) indicates a positive value of the desired slip frequency (fsd).

7. The device according to claim 1, comprising a second computing unit (14) configured for defining the third signal (S3) as a function of a fourth signal (S4) correlated to a detected rotor angular velocity (ωr), of a sixth signal (S6) correlated to a reference input velocity (ωi) supplied through a user interface (6), of a seventh signal (S7) supplied by the user interface (6) and correlated to a command for braking the electric machine (2), and of an eighth signal (S8) correlated to a reference voltage (Vr); the control device (5) preferably comprising a voltage-metering module (8) designed to supply the eighth signal (S8).

8. The device according to claim 7, wherein the second computing unit (14) comprises a fourth computing module (21) configured for defining a ninth signal (S9), correlated to a velocity error (ERR), from the comparison between the sixth signal (S6), correlated to the reference input velocity (cop, with the fourth signal (S4), correlated to the detected rotor angular velocity (ωr); and wherein the second computing unit (14) comprises a fifth computing module (22) configured for defining a tenth signal (S10) obtained by amplifying the ninth signal (S9) with a gain variable as a function of the fourth signal (S4).

9. The device according to claim 8, wherein the second computing unit (14) comprises a sixth computing module (23) configured for calculating an acceleration on the basis of the fourth signal (S4), and supplying an eleventh signal (S11) obtained by processing the tenth signal (S10) on the basis of the acceleration calculated and on the basis of a twelfth signal (S12) supplied by the user interface (6).

10. The device according to claim 9, wherein the second computing unit (14) comprises a seventh computing module (24) configured for defining a thirteenth signal (S13) on the basis of the eleventh signal (S11), of the fourth signal (S4), of the sixth signal (S6), and of the seventh signal (S7).

11. The device according to claim 10, wherein the second computing unit (14) comprises an eighth computing module (26) configured for defining the third signal (S3) obtained by processing the thirteenth signal (S13) as a function of the eighth signal (S8) and on the basis of the fourth signal (S4) so as to limit the desired slip frequency (fsd) to a maximum value as a function of the fourth signal (S4).

12. An electric propulsion system comprising: an asynchronous electric machine (2); a source of electrical energy (3) for supplying the asynchronous electric machine (2); and a control device (5) according to claim 1.

13. The electric propulsion system according to claim 12, comprising power switches (4) arranged between the source of electrical energy (3) and the electric machine (2) for supplying the operating voltage (V) to the electric machine (2); and a control unit (7) for the power switches (4), which is configured for controlling the power switches (4) so as to supply the operating voltage (V) on the basis of the first signal (S1) defined by the first computing unit (10) and of the second signal (S2); the control unit (7) preferably receiving at input a value of a reference voltage (Vr) of the source of electrical energy (3) and acting on the power switches (4) on the basis of the value of the reference voltage (Vr) of the source of electrical energy (3).

14. A method for controlling an asynchronous electric machine (2) comprising the step of defining a first signal (S1) correlated to an operating voltage (V) to be applied to the electric machine (2), as a function of a second signal (S2) indicating a desired stator frequency (f1d) of the operating voltage (V), and as a function of a third signal (S3) indicating a desired slip frequency (fsd) of the electric machine (2).

15. The method according to claim 14, comprising the steps of: defining the desired stator frequency (f1d) on the basis of the desired slip frequency (fsd) and on the basis of a detected rotor frequency of a rotor of the electric machine (2), preferably through the sum of said frequencies; and supplying a respective first value of the operating voltage (V) and a respective second value of the operating voltage (V) for each admissible value of a first desired quantity chosen between the desired slip frequency (fsd) and the desired stator frequency (f1d) of the electric machine (2).

16. The method according to claim 15, comprising the steps of: defining a set of voltage values as a function of a value of the first desired quantity and of the first and second values of operating voltage (V) associated to the value of the first desired quantity; and defining a value of the operating voltage (V) to be applied to the electric machine (2), comprised in a set of voltage values, as a function of a second desired quantity chosen between the desired stator frequency (f1d) and the desired slip frequency (fsd) and distinct from the first desired quantity.

17. The method according to claim 15, comprising the steps of: selecting a plurality of values of operating voltage (V) to be supplied at input to the electric machine (2), on the basis of the desired stator frequency (f1d); and selecting a value of voltage within of the plurality of selected voltage values, on the basis of the desired slip frequency (fsd).

18. The method according to claim 16, wherein the step of defining the value of the operating voltage (V) operates with:
a zero value of the desired slip frequency (fsd), if the desired slip frequency (fsd) is negative; and a value of the desired slip frequency (fsd) deriving from the value of desired slip frequency (fsd) modified on the basis of a fifth signal (S5) supplied by a user interface (6), if the desired slip frequency (fsd) is positive.

19. The method according to claim 14, comprising the steps of: supplying a reference input velocity (ωi) via a user interface (6); and defining the desired slip frequency (fsd) on the basis of the detected rotor angular velocity (ωr) and on the basis of the reference input velocity (ωi).

20. The method according to claim 19, comprising the steps of issuing a command for braking the electric machine (2) through the user interface (6), and supplying a reference voltage (Vr) of a source of electrical energy (3) of the electric machine (2); and wherein the step of defining the desired slip frequency (fsd) comprises using the braking command and the reference voltage (Vr).
